(19) United States
(12) Patent Application Publication
(10) Pub. No.: US 2010/0312672 A1
(43) Pub. Date: Dec. 9, 2010

(54) Electric restaurant marketplace

(76) Inventors: R. Andrew Lella, Gatesville, TX (US); Dennis Fehler, McGregor, TX (US)

Correspondence Address: ABELMAN, FRAYNE & SCHWAB, 666 THIRD AVENUE, 10TH FLOOR, NEW YORK, NY, 10017, US

(21) Appl. No.: 12/802,364

(22) Filed: Jun. 4, 2010

Related U.S. Application Data
(60) Provisional application No. 61/184,216, filed on Jun. 4, 2009.

(51) Int. Cl. G06Q 30/00; G06Q 50/00

(52) U.S. Cl. 705/27

(57) ABSTRACT

A system for determining the best price of food-related products comprises an input device for receiving a selection of food-related products from a user and a computer. The computer has a communications interface with the interne, a memory for storing a plurality of addresses associated with various vendors, and a processor coupled to the input device for receiving from the user a selection of one or more food-related products. In response to receiving a selection from a user, the computer generates and transmits bid requests to a plurality of the vendors, receives bids from the vendors, determines the best price, and displays to the user the best price and vendor for the selected product or products.

### CROSS-REFERENCE TO RELATED APPLICATIONS

This application claims priority on U.S. provisional application No. 61/184,216, filed on Jun. 4, 2009.

### BACKGROUND OF THE INVENTION

This invention relates to the food service industry, and in particular is directed to a system and method for implementing an electronic restaurant marketplace to obtain the best prices for goods in the food industry.

The application of technology for improved delivery and access to food stuffs is well known. In the 1850's, the can opener was considered the latest or best technology available in the United States. Since the development and applications of computers to commerce, the food service industry has considered Point of Sale (POS) hardware and software to be the pinnacle of current technology. POS machines track sales, labor, and payroll, and generate records helpful in accounting and bookkeeping.

The Point of Sale technology is focused on time efficiencies, recipe costing, inventory control, and labor management. POS systems are a necessity but, for all of their powerful technology, POS systems do not guarantee that a buyer will obtain the best pricing from the vendors and suppliers which the buyer typically uses.

### BRIEF SUMMARY OF THE INVENTION

A system and method implement an electronic restaurant marketplace to obtain the best prices for goods in the food industry. The system and method include computer hardware and software to implement an Internet-based service that allows a restaurant owner, operator, or manager to simultaneously submit multiple silent bid requests to individual vendors to achieve the best negotiated pricing on all purchased products. The individual vendors respond with bids to provide food stuffs and other products, and a computer-based method compares such bids to determine the best prices.

### BRIEF DESCRIPTION OF THE SEVERAL VIEWS OF THE DRAWINGS

Preferred embodiments of the invention are disclosed hereinbelow with reference to the drawings.

FIG. 1 is a schematic of the system of the present invention.

FIG. 2 is a flowchart of operation of the method of the present invention.

FIG. 3 is a display of vendors and prices.

FIG. 4 is an enhanced display of vendors and prices.

FIG. 5 is a summary display of best prices.

### DETAILED DESCRIPTION OF THE INVENTION

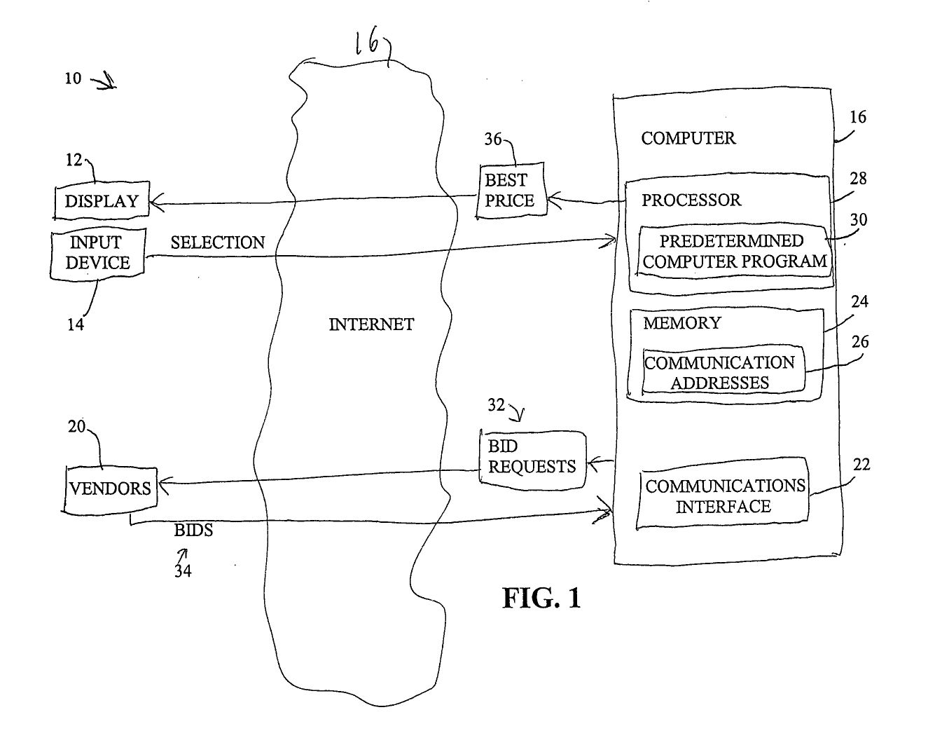

As shown in FIGS. 1-5, the system 10 and method of the present invention an electronic restaurant marketplace to obtain the best prices for goods in the food industry. The system 10 and method include computer hardware and software to implement an Internet-based service.

Using the system 10 and method, a user such as a restaurant owner, operator, or manager is able to simultaneously submit multiple silent bid requests to individual vendors to achieve the best negotiated pricing on all purchased products. The individual vendors respond with bids to provide food stuffs and other products, and a computer-based method compares such bids to determine the best prices.

Referring to FIG. 1, the system 10 includes a display 12 visible to a user, an input device 14 accessible to the user, and a computer 16 connected to the Internet 18 to communicate with a plurality of vendors 20. The computer includes a communications interface 22 connected to the Internet 18 and to the display 12 and the input device 14, a memory 24 for storing a plurality of communication addresses 26 associated with a plurality of vendors 20, and a processor 28 operating a predetermined computer program 30 for receiving a selection of a food-related product from the user through the input device 14, for generating and transmitting bid requests 32 over the Internet 18 to the plurality of vendors 20 at the communication addresses 26 to request a vendor price of the selected food-related product, for receiving bids 34 from the plurality of vendors 20 to provide the selected food-related product at respective bid prices, and for processing the prices in the bids 34 of determine the best price 36. The display 12 displays to the user the best price 36 and the vendor associated with the best price 36 for the selected food-related product.

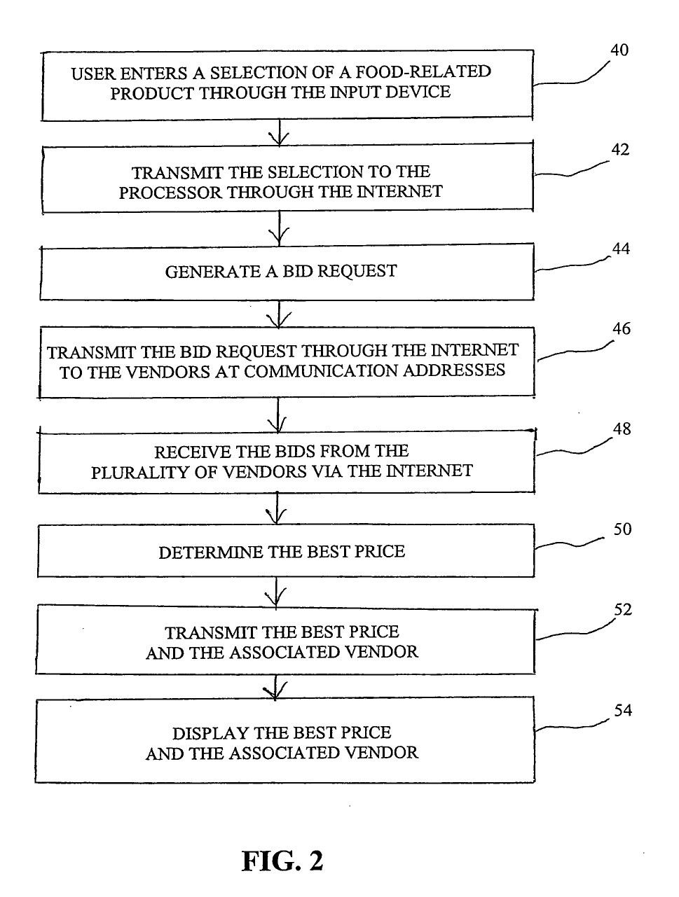

Referring to FIG. 2, the method of the present invention includes the steps of having a user enter a selection of a food-related product in the style and language most familiar to the user, through the input device 14 in step 40, transmitting the selection to the processor 28 through the Internet 16 in step 42, generate a bid request 32 in step 44, and transmitting the bid request 32 through the Internet 16 to the vendors 20 at the communication addresses 26 in step 46.

The method then includes the steps of receiving the bids 34 from the plurality of vendors 20 via the Internet 16 in step 48, determining the best price 36 in step 50, transmitting the best price 36 and the associated vendor in step 52, and displaying the best price 36 and the associated vendor in step 54.

Using the present invention, the user, such as a purchaser for a restaurant or a chain of restaurants, delicatessens, cafés, etc., is provided with the ability to consistently cherry pick the best prices on each food or supply item from each of your usual vendors and suppliers. Through a predetermined website with webpages accessible by the user through the display 12 and the input device 14, and by the vendors 18, the present system 10 and method implement an Internet-based software service that allows a restaurant owner, operator, or manager to simultaneously submit multiple silent bid requests to individual vendors 18 to achieve the best negotiated pricing on all purchased products. The predetermined website may be commercially available through a company using the trademark “LOWERFOODCOST” as well as having “LOWERFOODCOST” in a Uniform Resource Locator (URL) associated with the website.

The system 10 and method always reveal the best item prices and the best sources for all selected food items and supplies.

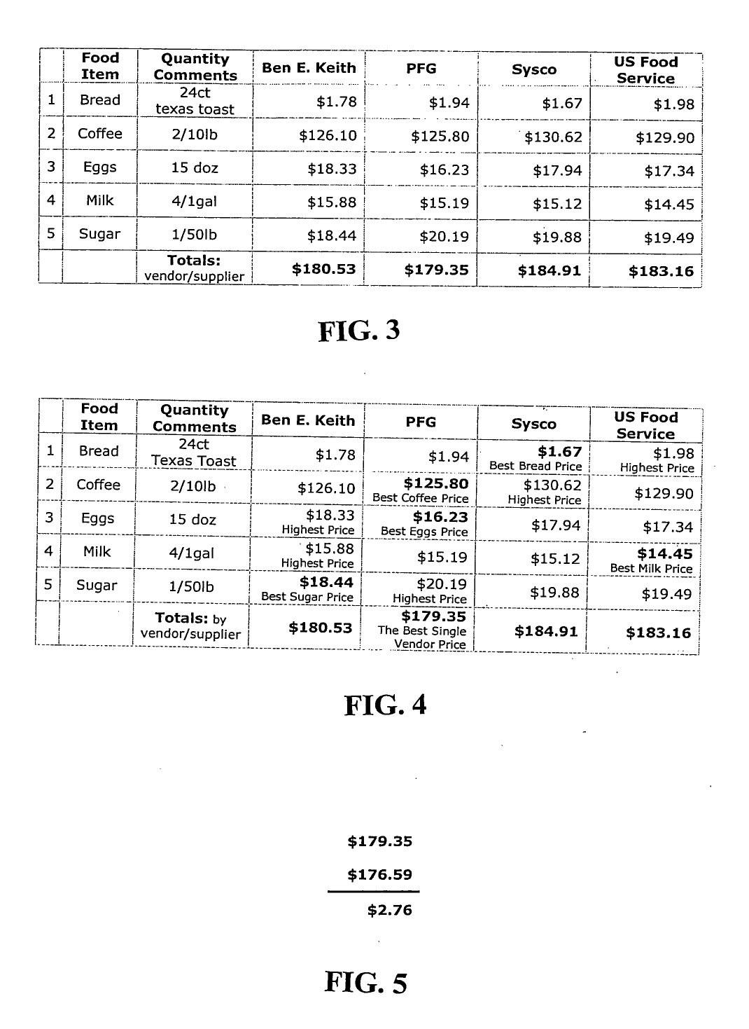

For example, as shown in FIG. 3, a user, using the input device 14, enters user selections to choose at least five items that the user may order on a daily or weekly basis. The five items may be displayed in a grid on a webpage on a display 12 for viewing by the user, allowing selections to be input through a keyboard and/or through a graphic user interface (GUI) using a mouse or other types of input devices 14.

The user, such as a restaurant representative, is able to organize the online inventory of the items and quantities required for the operations of the next week. The product items for the next week are selected from an exhaustive list by clicking on a checkbox or highlight the name of the food item which identifies that the selected item as needed.

The user can then specify the exact quantity for each item, and, of course, items can be requested by brand, or by packaging, and instructions to the vendors are optional for each item ordered. At the click of a button, the completed order is then posted on a secure online location for vendors to review and provide the best current pricing. The restaurant representative has the option to print a paper copy and the order information is retained in an order database in the memory 24. Propriety vendor information may be labeled as exclusive, and so may possible be prevented from being shared with other restaurants.

By making the selections, the user asks current vendors 18 or suppliers, as well as a set of enrolled or registered vendors 18 associated with the system 10, to quote a price to the user for each item. The current vendors and/or enrolled or registered vendors 18 may be associated or affiliated with the system 10 and accessible to any user using the system 10 after a enrolment or registration process, by which the communication address 26 of an enrolled vendor 18 is entered and stored in the memory 24.

Similarly, to use the system 10 and method, a user such as a restaurant representative may be required to first register as a new user, and create an account by providing a username, password, and basic credit card information including contact information and a mailing address. The information on each vendor 18 that a specific restaurant is currently doing business with may also be entered and provided.

The restaurant representative may organize a grocery and purchased product list electronically, and divide the usually lengthy item listing by product categories such as: freezer, cooler, or dry goods. The system 10 may provides several list editing tools to easily convert lists of food products and vendors to electronic form for use by the system 10.

When the user makes the selection, the user may be able to specify an exact number of items, counts, quantities, or other restrictions on the items to be priced. The user may complete a worksheet table as shown in FIG. 3, with the item prices for each vendor 18 displayed on the display 12.

Since it is typical that no single vendor consistently provides the best or lowest item pricing, the system 10 and method of the present invention electronically stores the most current prices from each of the vendors 18 for each of the available items.

Once the selections by users are made, the system 10 generates the bid requests 32, which prompts the vendors 18 to generate their bids 34 with the prices which each vendor contracts to supply the items in the specified quantities.

After all of the bids 34 and their prices are received by the processor 28, the predetermined computer program 30 scans the prices, and fmds and selects the lowest price for each food item from each of the vendors 18, as shown in FIG. 4. The system 10 may then send the best prices 36 to be displayed on the display of the user making the selections, with all of the available prices being displayed, for example, in table form as shown in FIG. 4, with the best prices 36 highlighted, for example, using different colors or shading of backgrounds of the text.

The system 10 may also identify any best food item prices identified by each vendor, such as the best sugar price, the best bread price, etc., as shown in FIG. 4.

As shown in FIG. 5, the system 10 and method may also have the processor 28 generate and display to the user a summary screen or table of best food item pricing, in which the system 10 identifies and displays in the upper cell of the table a best single vendor in terms of total pricing, also identifies and displays, for example, the five best food item prices of all vendors in a middle cell of the table in FIG. 5, and identifies and displays in a lower cell a difference between the best single vendor pricing and the best five item prices among all the vendors. Using FIG. 5, the user is able to compare and determine the savings which would be gained by using a single vendor as per the upper cell, or using diverse vendors, as per the middle cell in FIG. 5. For example, if the difference between the upper and middle cells is positive, as shown in the lower cell, spreading out the purchase orders among different vendors is more economical. In other pricing scenarios, for example, if the value of the lower cell in FIG. 5 is negative, it would be better to use a single vendor. Alternatively, if the value of the lower cell is inconsequential, such as the positive difference being below $0.50 or any other predetermined threshold, a user may determine that using a single vendor may be more reliable despite an incremental extra cost associated with using the single vendor despite some nominal savings in costs.

Using the system 10 and method, the present invention provides Internet-base technology which allows users to be certain that their vendors and suppliers are actually offering the user the best possible prices by providing the user with a direct “vendor to vendor” and “item for item” comparison of prices using a bid request system.

The ability to selectively choose the best vendor for each food item by price can consistently save users thousands of dollars over long periods of time, week after week, month after month.

The restaurant representative then simply selects the item from the appropriate vendor based on price, convenience, or other criteria, and the appropriate final orders or sent to the appropriate vendors. Multiple orders to each vendor can be printed if necessary, and the order information may be maintained in the memory 24 as an order database.

What is claimed is:

1. A system for determining a best price of food-related products, the system comprising:
an input device for receiving a selection of a food-related product from a user;
a computer including:
a communications interface connected to the Internet;
a memory for storing a plurality of communication addresses associated with a plurality of vendors; and
a processor for receiving the selection of the food-related product from the user, for generating and transmitting bid requests over the Internet to a plurality of vendors at the communication addresses to request a vendor price of the selected food-related product, for receiving bids from the plurality of vendors to provide the selected food-related product at respective bid prices, and for processing the bid prices to determine the best price; and
a display for displaying to the user the best price and the vendor associated with the best price for the selected food-related product.
